(19) United States
(12) Patent Application Publication
(10) Pub. No.: US 2017/0289014 A1
(43) Pub. Date: Oct. 5, 2017

(54) REDUNDANY SYSTEM OF ROUTING PATHS AND METHOD THEREOF

(71) Applicant: MOXA INC., New Taipei City (TW)

(72) Inventors: Kuo-Wei HSU, New Taipei City (TW); Chih-Chiang LAI, New Taipei City (TW); Shih-Chia YEN, New Taipei City (TW); Wen-Che HSU, New Taipei City (TW); Chien-Yu LAI, New Taipei City (TW)

(21) Appl. No.: 15/088,166

(22) Filed: Apr. 1, 2016

(51) Int. Cl. H04L 12/751; H04L 12/707; H04L 12/721; H04L 12/42

(52) U.S. Cl. CPC H04L 45/02; H04L 12/42; H04L 45/24; H04L 45/26

(57) ABSTRACT

The present invention relates to a redundancy system of routing paths and method thereof. By establishing corresponding routing paths from different ports of routers in a ring network to a terminal in advance and transmitting the identical packet to the terminal by the different ports in the different routing paths simultaneously, the time of reestablishing the routing paths may be saved when one of the routing paths is broken, so as to improve the routing efficiency.

### BACKGROUND OF RELATED ARTS

### Technical Field

The present invention relates to a redundancy system of routing paths and method thereof; in particularly, to a redundancy system of routing paths and method thereof capable of transmitting the identical unicast packet to a terminal by the different ports in the different routing paths.

### Description of Related Arts

Recently, the industry control has strict demands over the network stability. In practice, the stability and the reliability of the network usually may be realized by going with a redundancy mechanism or a backup mechanism.

In general, in a network environment provided with lots of devices connected with each other, such as the environment or solar power plant with many network monitors, in order to correctly transmit packets from a source end to a terminal, a router has to establish a routing path for each apparatus correspondingly. However, when the routing path is broken, it may take much time to reestablish the routing path as well. As a result, the routing efficiency may be influenced.

In view of this, some companies have proposed an improved approach containing a master router and a backup router. When the master router is not working, the backup router may be switched to perform the routing process instead. However, this approach is workable only when the router makes the routing path interrupted. If the broken apparatus is one switch in the routing path, the router may still need to reestablish the routing path. Therefore, the routing efficiency problem still may not be overcome as well.

In summary, for the prior arts, the routing efficiency problem in the network environment with lots of apparatuses is existed for quite some time. When the routing path is broken, it needs to take much time to reestablish the routing path, resulting in a poor routing efficiency. Therefore, it requires an improved technology to solve the problem indeed.

### SUMMARY

Based on the problems and the drawbacks for the conventional redundancy system, the inventor concentrates on the solution and develops the disclosure by years of practical experience in this field and wealth of professional knowledge. After trying and modifying the disclosure continuously, the inventor has designed a redundancy system capable of transmitting the identical unicast packet to a terminal by the different ports in the different routing paths.

The first objective of the present invention is to provide a redundancy system of routing paths for a router used in a ring network. The redundancy system includes a routing module and a transmission module. The routing module is configured to establish a first routing path from a first port of the router to a terminal and establishes a second routing path to a second port of the router to the terminal by in advance. The transmission module is configured to transmit the unicast packet by the first routing path and the second routing path simultaneously.

The second objective of the present invention is to provide a redundancy method of routing paths for a router used in a ring network. The redundancy method includes following steps. The router establishes a first routing path from a first port thereof to a terminal in advance and establishes a second routing path from a second port thereof to the terminal in advance. The router transmits a unicast packet by the first routing path and the second routing path simultaneously.

The aforesaid description discloses the system and method of the present invention. The major difference between the present invention and the prior arts is that this disclosure establishes different routing paths to the terminal by the different ports of the routers in the ring network in advance and transmits the identical packet to the terminal by the different ports in the different routing paths simultaneously.

By means of above design, the present invention can save the time of reestablishing the routing paths when one of the routing paths is broken, so as to improve the routing efficiency.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram of a redundancy system of routing paths of the present invention.

FIG. 2 is a flow chart of a redundancy method of routing paths of the present invention.

FIG. 3A is a view of a ring network connected to a chain network capable of handling a redundancy process.

FIG. 3B and FIG. 3C are views of transmitting a unicast packet after an interrupted status or in a blocked status of the present invention.

FIG. 4 is a view of transmitting a unicast packet after the interrupted status or the blocked status is eliminated, in accordance with the present invention.

FIG. 5 is a view of a ring network of the present invention connected to another ring network capable of handling a redundancy process.

FIG. 6 is a view of a ring network of the present invention connected to a mesh topology capable of handling a redundancy process.

### DETAILED DESCRIPTION OF THE EMBODIMENTS

Reference will now be made in detail to the exemplary embodiments of the present invention, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

The environment applied to the present invention is described first before representing the redundancy system of routing paths and method thereof. This present invention is applied to at least one router in a ring network. In an embodiment, the ring network may connect to a network topology capable of handling a redundancy process, such as a chain network, a ring network, a mesh network, or etc. The network topology has a first switch and a second switch, where the first switch connects to the ring network at a main port thereof and the second switch connects to the ring network at a backup port thereof. Besides, the blocked status of the present invention indicates that the switches in the network topology or the ring network are allowed to control packets only but the switches are not allowed to transmit general data packets to the next switch by their ports. The interrupted status of the present invention indicates that the physical cable or the port is damaged, resulting in an invalid packet transmission. The conductive status of the present invention indicates that the switches in the network topology or the ring network are allowed to transmit the general data packets to the next switch by their ports. In particular, when one of the main port and the backup port is in the conductive status, the other is in the blocked status. In an embodiment, the preset of the main port of the first switch is in the conductive status, and the preset of the backup port of the second switch is in the blocked status.

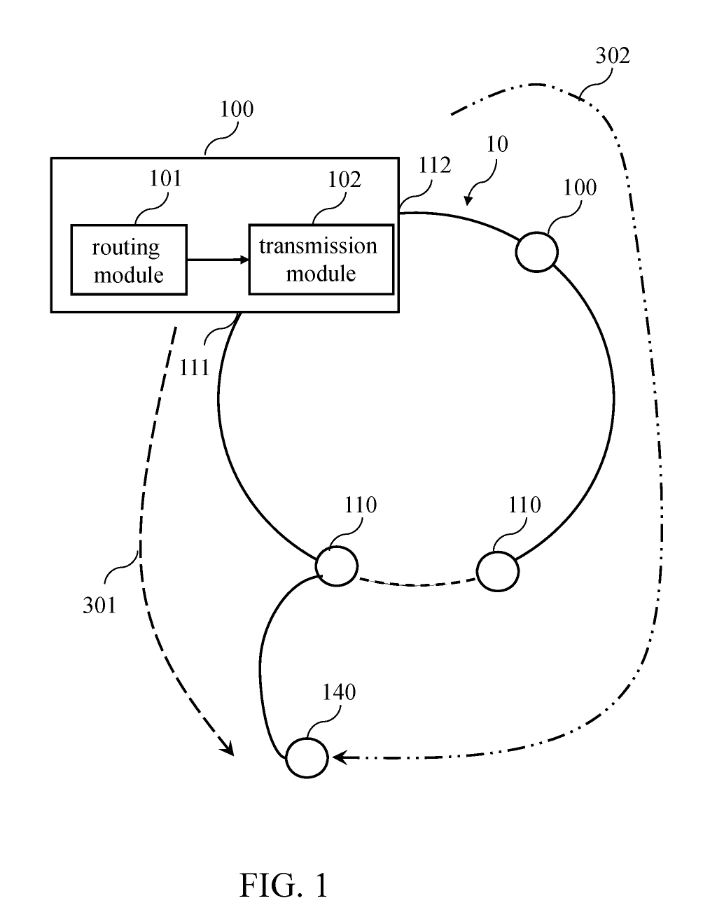

Reference will now be made in detail to the redundancy system of routing paths and method thereof of the present invention, examples of which are illustrated in the accompanying drawings. Please refer to FIG. 1 which is a block diagram of a redundancy system of routing paths of the present invention. The redundancy system is used for at least one router 100 in a ring network 10 and includes a routing module 101 and a transmission module 102. The routing module 101 establishes a first routing path 301 from a first port 111 of the router 100 to a terminal 140 in advance, and establishes a second routing path 302 from a second port 112 of the router 100 to the terminal 140 in advance. In the embodiment, the routing module 101 may base the ARP (Address Resolution Protocol) to generate the first routing path 301 and the second routing path 302. Because the ARP belongs to the technology of the prior arts, the repetitious details need not be given here. Besides, in the embodiment of the present invention, the routing module 101 may further transmit an update message having the first routing path 301 and the second routing path 302 to the neighboring routers 100 and receive the update message from the neighboring routers 100 to update the routing path. Therefore, one router 100 may assist the others routers 100 in establishing the routing table, so as to save the time and the network bandwidth for establishing the routing table. It is worth to be mentioned, the ring network 10 may further include a general switch 100 connecting the terminal 140 or the network topology. Take FIG. 1 for example, the ring network 10 has two switches 110, and a preset connection between the two switches 110 may be in the blocked status, so as to avoid the looping problem.

The transmission module 102 may transmit a unicast packet via the first routing path 301 and the second routing path 302 simultaneously. When the first routing path 301 is in the interrupted status or in the blocked status, the identical unicast packet can be transmitted by the transmission module 102 by the first routing path 301 and the second routing path 302 simultaneously, so it has no necessary to reestablish the routing path, and the unicast packet may be transmitted to the terminal 140 by the second routing path 302. Similarly, when the second routing path 302 is in the interrupted status or in the blocked status, it has no necessary to reestablish the routing path as well because the unicast packet may be transmitted to the terminal 140 by the first routing path 301. As a result, the time for checking if the routing path is in the interrupted status or in the blocked status and the time for replacing the routing path may be saved. In the embodiment of the present invention, the whole system may avoid the looping problem by using the blocked mechanism. Although the unicast packet is transmitted by the two paths at the same time, such as the first routing path 301 and the second routing path 302, the terminal 140 may receive one unicast packet only and no other transmission problem will be made.

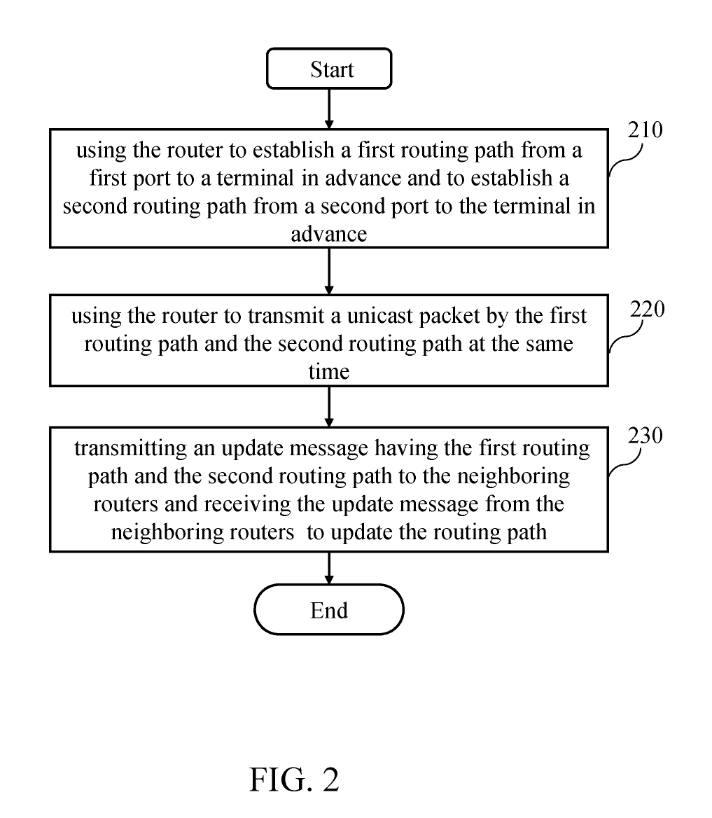

Next, please refer to FIG. 2 which is a redundancy method of routing paths of the present invention. The redundancy method is used for a router 100 in a ring network 10, and the redundancy method includes steps as follows. In the step 210, the router 100 is used to establish a first routing path 301 from a first port 111 to a terminal 140 in advance and to establish a second routing path 302 from a second port 112 to the terminal 140 in advance. In the step 220, the router 100 is used to transmit a unicast packet by the first routing path 301 and the second routing path 302 at the same time. With the above steps, different routing paths (such as the first routing path 301 and the second routing path 302) to the terminal 140 may be established by the different ports (such as the first port 111 and the second port 112) of the router 100 in the ring network 10 in advance, and the identical unicast packet may be transmitted to the terminal 140 by the different ports (such as the first port 111 and the second port 112) in the different routing paths (such as the first routing path 301 and the second routing path 302) simultaneously.

Besides, after the step 220, in the step 230 an update message, which has the first routing path 301 and the second routing path 302, is transmitted to the neighboring routers 100 and the update message is received from the neighboring routers 100 to update the routing path. For example, it's assumed that there are a master router and a backup router of the present invention. The master router may set the current first routing path 301 and the current second routing path 302 as the update message, and transmit the update message to the neighboring backup router for updating the routing table of the backup router.

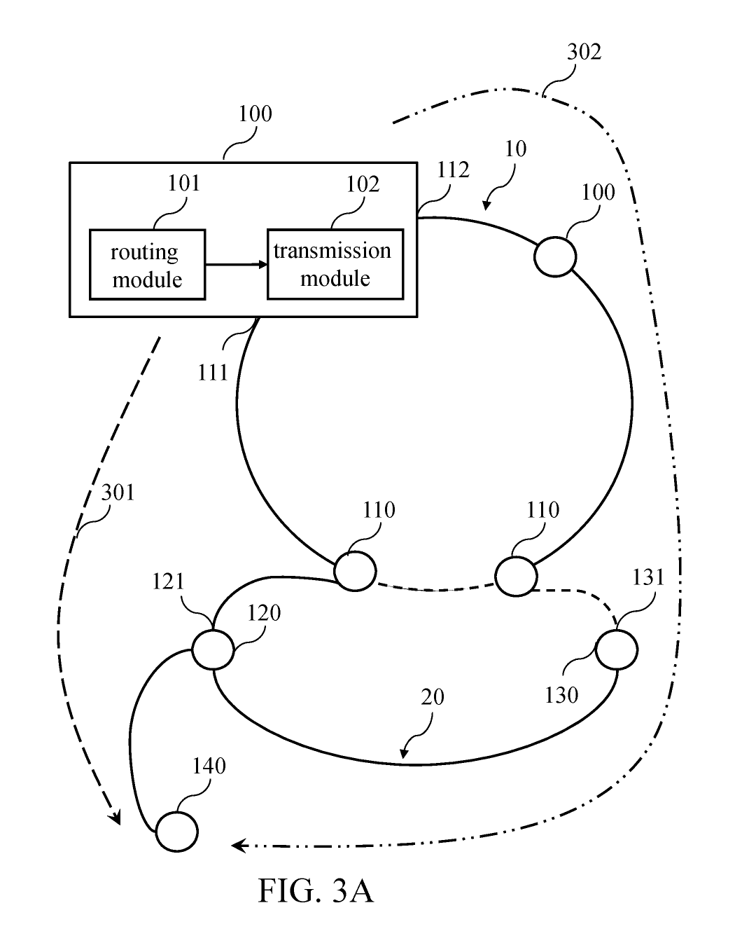

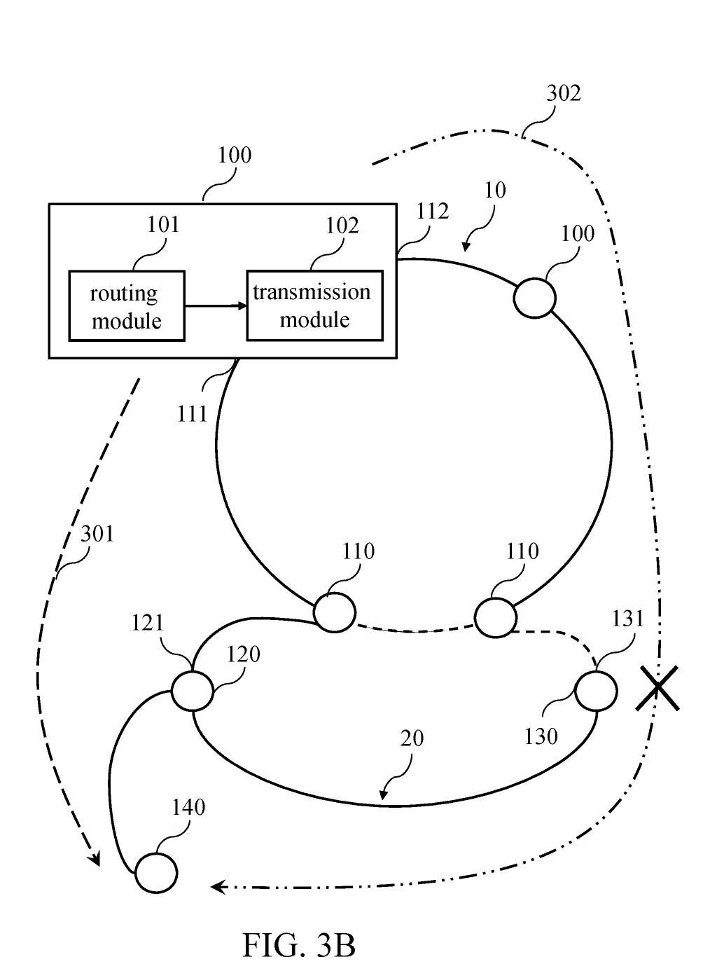

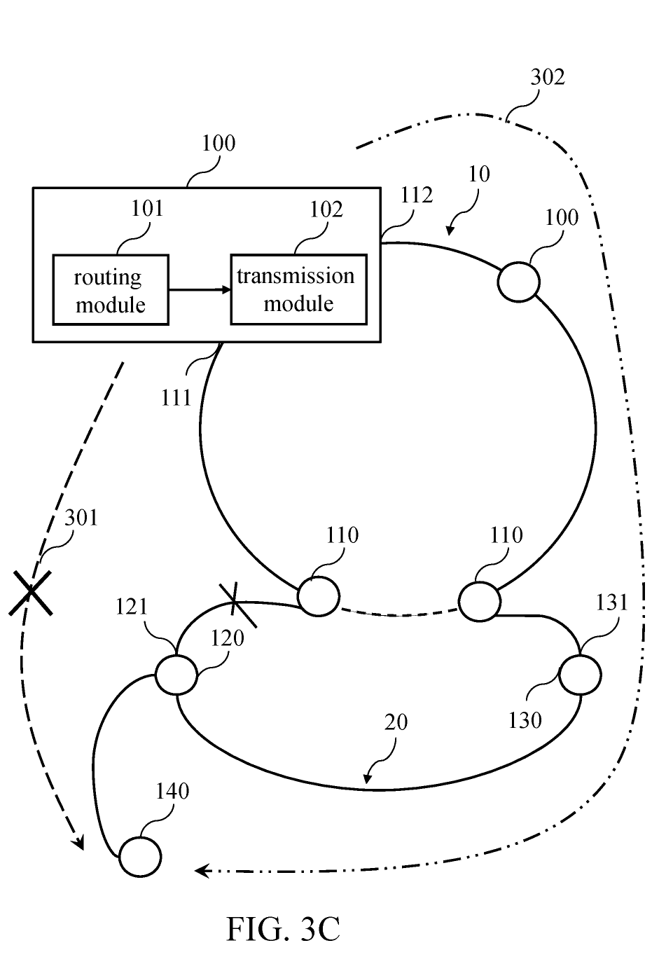

Examples of an embodiment are illustrated in the accompanying FIG. 3A to FIG. 6. Please refer to FIG. 3A which is a view of a ring network connected to a chain network capable of handling a redundancy process. As aforesaid, the ring network 10 may connect to the chain network 20 capable of handling the redundancy process. In an embodiment of the present invention, the chain network 20 may have a first switch 120 and a second switch 130. The first switch 120 connects to the ring network 10 via a main port 121 thereof, and the second switch 130 connects to the ring network 10 via a backup port 131 thereof. The main port 121 is preset in the conductive status, and the backup port 131 is preset in the blocked status. In the situation, the first routing path 301 goes through the main port 121 of the first switch 120, and the second routing path 302 goes through the backup port 131 of the second switch 130. When the main port 121 is in the interrupted status or in the blocked status, the backup port 131 may become in the conductive status and the unicast packet may be transmitted to the terminal 140 via the second routing path 302. When the backup port 131 is in the interrupted status or in the blocked status, the main port 121 may become in the conductive status and the unicast packet may be transmitted to the terminal 140 via the first routing path 301. By using the blocked mechanism, the looping problem may be avoided. The unicast packet may be transmitted to the terminal 140 successfully by one of the first routing path 301 and the second routing path 302 at a time only.

Please refer to FIG. 3B and FIG. 3C, which are views of transmitting a unicast packet after being in an interrupted status or in a blocked status of the present invention. At first, in the network environment illustrated in FIG. 3A, the different routing paths (such as the first routing path 301 and the second routing path 302) to the terminal 140 may be established by the different ports of the router 100 in the ring network 10 (such as the first port 111 and the second port 112) in advance, as illustrated in FIG. 3B, so the transmission module 102 will transmit the unicast packet by the first routing path 301 and the second routing path 302 simultaneously. The unicast packet may not be transmitted to the terminal 140 because the first routing path 301 or the second routing path 302 is in the interrupted status or in the blocked status. As illustrated in FIG. 3B, the backup port 131 of the second switch 130 is in the blocked status, so the unicast packet transmitted by the transmission module 102 via the second routing path 302 may not be delivered to the terminal 140 successfully. Next, as shown in FIG. 3C, when the main port 121 of the first switch 120 of the chain network 20 is in the blocked status or a cable connecting to the main port 121 and the ring network 10 is in the interrupted status, the redundancy mechanism of the chain network 20 may be started, so as to switch the blocked status of the backup port 131 of the second switch 130 to the conductive status. At this moment, the unicast packet may not be transmitted to the terminal 140 via the first routing path 301 because of the interrupted status of the cable, but the unicast packet may still be transmitted to the terminal 140 by the second routing path 302 after switching the blocked status of the backup port 131 of the second switch 130 to the conductive status. In other words, because the backup port 131 has been in the conductive status, the unicast packet may be transmitted between the router 100 and the terminal 140 via the second routing path 302. In the above process, the router 100 does not need to take much time to judge if the routing path is in the interrupted status or in the blocked status and does not need to take much time to replace and reestablish the routing path, and then the terminal 140 may receive the transmitting packet by the other routing path, so as to effectively improve the routing efficiency.

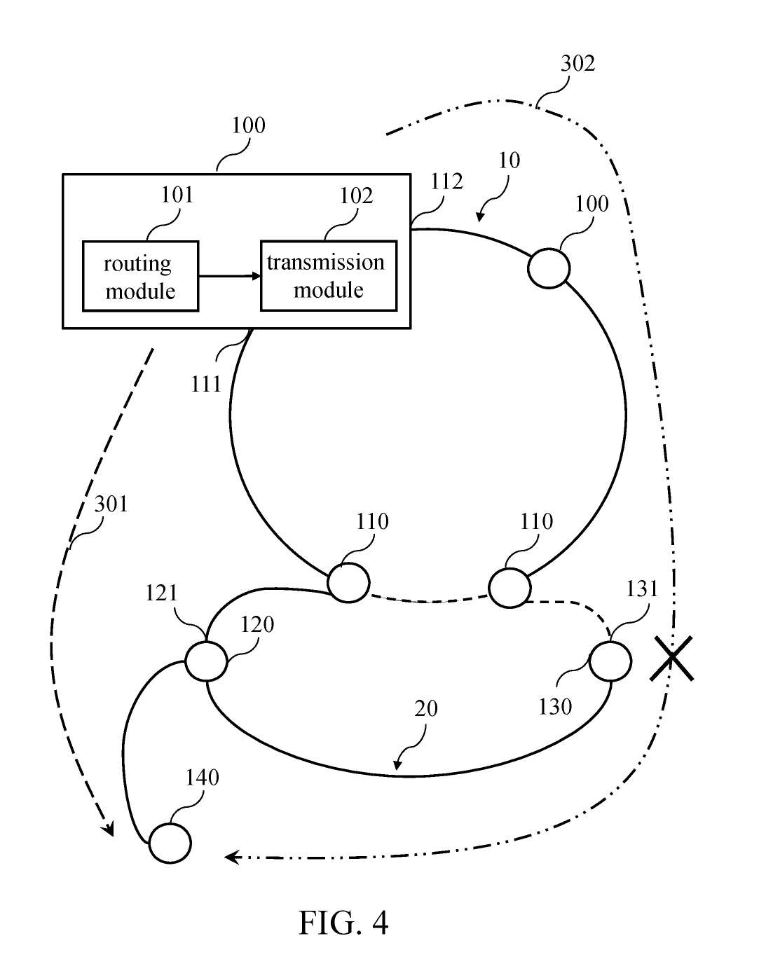

Please refer to FIG. 4 which is a view of transmitting a unicast packet after eliminating an interrupted status or a blocked status of the present invention. When the main port 121 of the first switch 120 in the chain network 20 is in the conductive status and is able to communicate with the ring network 10, the conductive status of the backup port 131 of the second switch 130 in the chain network 20 is switched to the blocked status. Thus, the unicast packet transmitted by the transmission module 102 via the first routing path 301 may be delivered to the terminal 140 successfully. Besides, the unicast packet transmitted by the second routing path 302 may not be delivered to the terminal 140 because the backup port 131 of the second switch 130 is in the blocked status. In other words, when the main port 121 is in the interrupted status or in the blocked status, the unicast packet may be transmitted to the terminal 140 via the second routing path 302 because of the conductive status of the backup port 131. When the backup port 131 is in the interrupted status or in the blocked status, the unicast packet may be transmitted to the terminal 140 via the first routing path 301 because of the conductive status of the main port 121. As a result, when the terminal 140 has many fixed network topologies, the time for reestablishing the routing may be saved effectively.

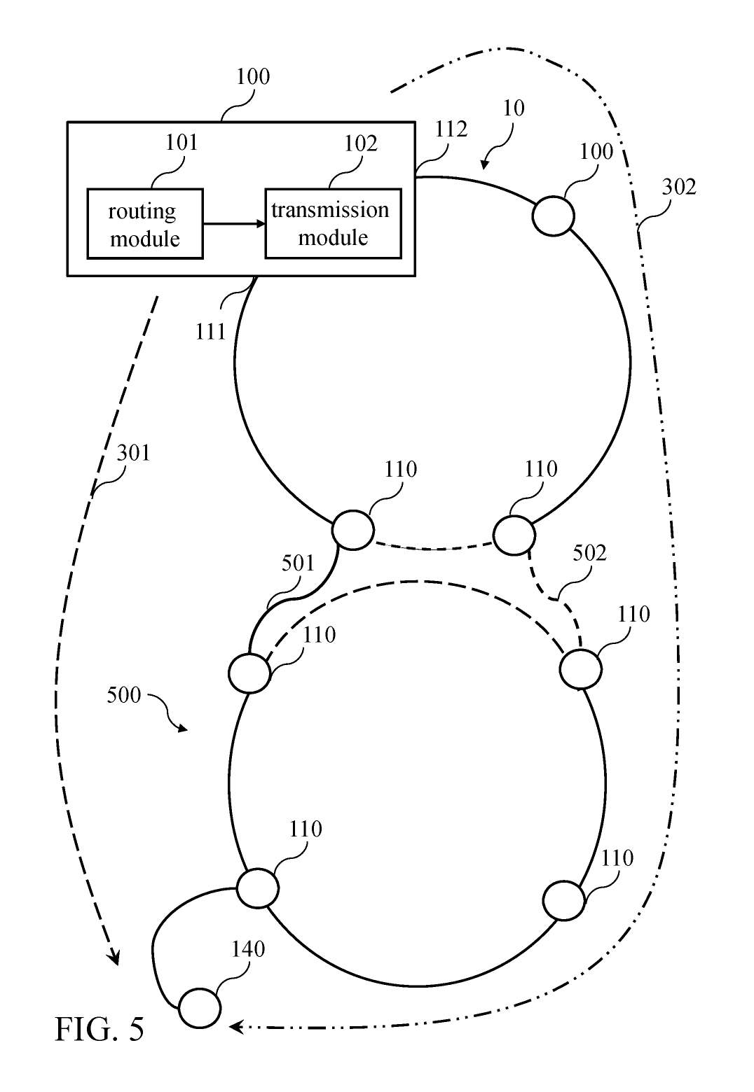

Please refer to FIG. 5 which is a view of a ring network of the present invention connected to another ring network capable of handling a redundancy process. In practice, the ring network 10 of the present invention is not only capable of connecting to a chain network 20 but also capable of connecting to any other network topology enables to handle a redundancy process, such as another ring network, a mesh network or etc. Take FIG. 5 for example, the ring network 10 connected another ring network 500 through link 501 and link 502. The solid line of link 501 indicates the link is predefined in a conductive status, and the dashed line of link 502 means the link is predefined in a blocked status. In this embodiment, the unicast packet transmitted by the transmission module 102 through a first routing path 301 may be transmitted to the terminal 140 by link 501, but the unicast packet transmitted through a second routing path 302 may not be transmitted to the terminal 140 by link 502 because link 502 is in the blocked status. The unicast packet transmitted through the second routing path 302 may be transmitted when the link 501 is in interrupted status or blocked status and the link 502 becomes conductive status.

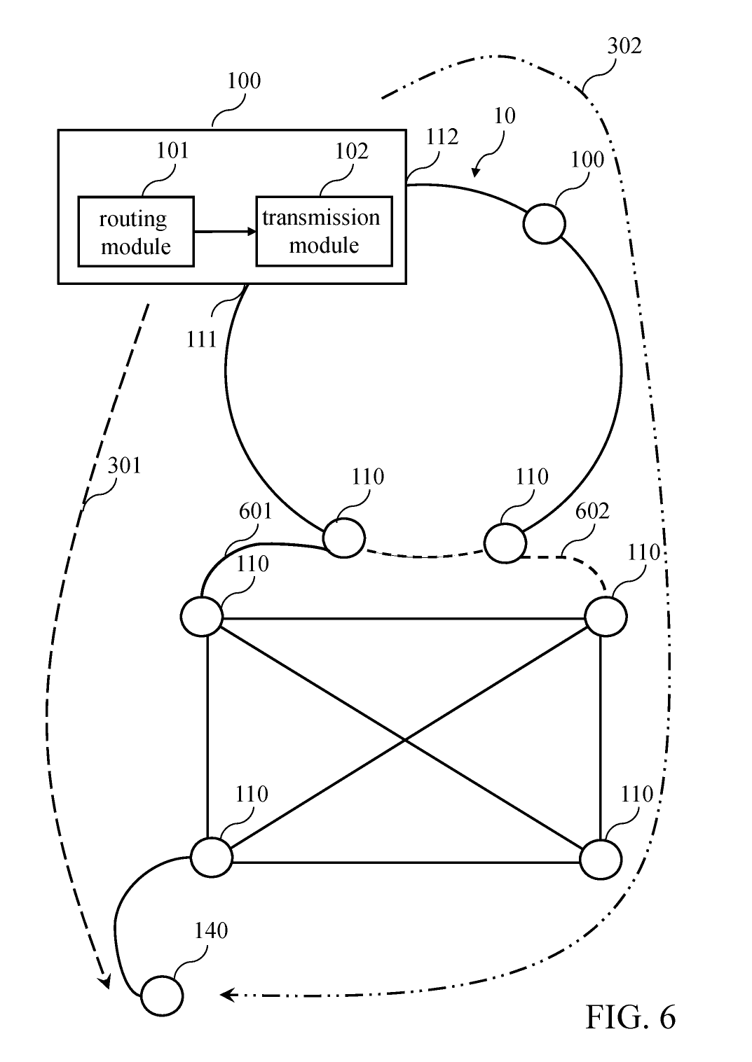

Please refer to FIG. 6 which is a view of a ring network of the present invention connected to a mesh topology capable of handling a redundancy process. In practice, the ring network 10 may connect to a mesh topology capable of handling a redundancy process (such as a mesh network 600) through link 601 and link 602. The solid line of link 601 indicates the link is predefined in a conductive status, and the dashed line of link 602 means the link is predefined in a blocked status. In this embodiment, the unicast packet transmitted by the transmission module 102 through a first routing path 301 may be transmitted to the terminal 140 by link 601, but the unicast packet transmitted through a second routing path 302 may not be transmitted to the terminal 140 by link 602 because link 602 is in the blocked status. The unicast packet transmitted through the second routing path 302 may be transmitted when the link 601 is in interrupted status or blocked status and the link 602 becomes conductive status. That is, the ring network 10 of the present invention may be applied to connect to any network topology capable of handling a redundancy process.

In summary, the difference between the present invention and the prior arts is that the present invention establishes the different routing paths by the different ports of the router in the ring network in advance and transmits the identical packet to the terminal by the different ports in the different routing paths simultaneously. Therefore, the problem existed in the prior arts can be overcome by using the technical means of the present invention, and the time of reestablishing the routing paths may be saved when one of the routing paths is broken, to improve the technical effect of the routing efficiency.

The above-mentioned descriptions represent merely the exemplary embodiment of the present invention, without any intention to limit the scope of the present invention thereto. Various equivalent changes, alternations or modifications based on the claims of present invention are all consequently viewed as being embraced by the scope of the present invention.

What is claimed is:

1. A redundancy system of routing paths for at least one router used in a ring network, the redundancy system comprising:
a routing module, configured to establish a first routing path from a first port of the router to a terminal in advance, and establishing a second routing path from a second port of the router to the terminal in advance; and
a transmission module, configured to transmit a unicast packet via the first routing path and the second routing path simultaneously.

2. The redundancy system according to claim 1, wherein the routing module further transmits an update message having the first routing path and the second routing path to neighboring routers of the router and receives the update message from the neighboring routers to update the first routing path and the second routing path.

3. The redundancy system according to claim 1, wherein the ring network connects to a network topology capable of handling a redundancy process, the network topology comprises a first switch and a second switch, the first switch connects to the ring network at a main port thereof, the second switch connects to the ring network at a backup port thereof, the main port is preset in a conductive status, the backup port is preset in a blocked status, the first routing path goes through the main port of the first switch, and the second routing path goes through the backup port of the second switch.

4. The redundancy system according to claim 3, wherein when the main port is in the interrupted status or in the blocked status, the backup port is in the conductive status and the unicast packet is transmitted to the terminal by the second routing path, and when the backup port is in the interrupted status or in the blocked status, and the main port is in the conductive status and the unicast packet is transmitted to the terminal by the first routing path.

5. The redundancy system according to claim 1, wherein the routing module bases the Address Resolution Protocol to generate the first routing path and the second routing path.

6. A redundancy method of routing paths for at least one router in a ring network, the redundancy method comprising steps of:
establishing a first routing path from a first port of the router to a terminal in advance, and establishing a second routing path from a second port of the router to the terminal in advance; and
transmitting a unicast packet by the router via the first routing path and the second routing path simultaneously.

7. The redundancy method according to claim 6, further comprising:
transmitting an update message having the first routing path and the second routing path to the neighboring routers of the router, and receiving the update message from the neighboring routers to update the first routing path and the second routing path.

8. The redundancy method according to claim 6, wherein the ring network connects to a chain network capable of handling a redundancy process, the chain network comprises a first switch and a second switch, the first switch connects to the ring network at a main port thereof, the second switch connects to the ring network at a backup port thereof, the main port is preset in a conductive status, the backup port is preset in a blocked status, and the first routing path goes through the main port of the first switch, and the second routing path goes through the backup port of the second switch.

9. The redundancy method according to claim 8, wherein when the main port is in the interrupted status or in the blocked status, the backup port is in the conductive status and the unicast packet is transmitted to the terminal by the second routing path, and when the backup port is in the interrupted status or in the blocked status, the main port is in the conductive status and the unicast packet is transmitted to the terminal by the first routing path.

10. The redundancy method according to claim 6, wherein the first routing path and the second routing path are established according to the Address Resolution Protocol.
